(19) United States
(12) Patent Application Publication
(10) Pub. No.: US 2004/0228998 A1
(43) Pub. Date: Nov. 18, 2004

(54) Curable film preform compositions

(76) Inventor: Hans E. Haas, Stow, OH (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/843,911

(22) Filed: May 12, 2004

Related U.S. Application Data
(60) Provisional application No. 60/469,731, filed on May 12, 2003.

(51) Int. Cl. B32B 9/00

(52) U.S. Cl. 428/40.1; 156/256; 156/265

(57) ABSTRACT

A curable preform in an uncured state has a tensile strength of greater than one pound per square inch and a film shape of a disk, washer, U-shaped piece, strip, and polygon and is sized to engage a fastener head underside. The preform is composed of a curable liquid precursor having a polymer powder mixed therethrough. The preform is well suited to efficiently secure a fastener adhesively to an object.

### RELATED APPLICATION

This application claims priority of U.S. Provisional Patent Application Ser. No. 60/469,731 filed May 12, 2003, which is incorporated herein by reference.

### FIELD OF THE INVENTION

The present invention generally relates to an adhesive or sealant preforms operative in repair or construction, and in particular, to a composition preformed as a peelable film shape.

### BACKGROUND OF THE INVENTION

Curable liquids have long been appreciated to have applications as adhesives. Difficulties associated with applying a curable liquid precursor in a work environment and the retention thereof at the desired application site have limited the practicable opportunities to use curable liquid precursors. The dispensing of a liquid composition onto anything other than the top of a horizontal surface necessarily leads to precursor run. Furthermore, many application environments such as repair of operating piping or machinery are simply incompatible with exchanging a curable liquid precursor applicator for tools.

In response to these limitations, numerous attempts have been made to incorporate substances into a curable liquid precursor in order to form a nonflowable or at least more viscous adhesive. These thickeners have traditionally included inorganic particulate, waxes, thermoplastic polymer powders, powders of polymers swelled by the liquid precursor, and polymers miscible with the liquid precursor. In the particular field of anaerobic curing thread lock compositions, U.S. Pat. No. 6,451,927 B1 and the references disclosed therein are exemplary of a thickened curable system that addresses the problem of liquid precursor run. While thickened adhesive and sealant compositions containing a curable material have largely succeeded in addressing the problem of run from the application situs, viscous liquid and gelatinous compositions containing a curable liquid have nonetheless met with limited success owing to the failure of these systems to address the practicalities of the usage setting as an applicator swab or stick is still required. The problem still persists that application of a viscous or gelatinous curable adhesive composition in a reproducible manner remains a time consuming and ultimately inexact activity. Prior art attempts to form films, gaskets and cut shapes of solidified anaerobic adhesive materials are exemplified by U.S. Pat. No. 3,625,875. These attempts have met with limited acceptance owing to inability to provide adequate bond strengths in large dimension installations such as gaskets and the need to be formed as a thin coating on a fastener. Thus, there exists a need for a curable composition usable as a solid or semisolid preform shape.

### SUMMARY OF THE INVENTION

A curable preform includes a curable liquid precursor having a polymer powder mixed therethrough such that the resulting preform has a tensile strength of greater than one pound per square inch. The preform has a film shape sized to engage the shaft of a conventional fastener such as a screw, bolt, nail or rivet. The shape including a disk, washer, U-shaped piece, strip, regular polygon, or irregular polygon in conformance to a fastener shaft or head underside. As a fastener is secured to an object, the preform shape is deformed and fills spaces between the fastener and the object for subsequent cure in that position.

A process for creating a solid or semisolid curable preform according to the present invention includes admixing with 20 to 98 total weight percent of a curable liquid precursor a polymer powder in an amount of from 2 to 80 total weight percent to form a pourable liquid mixture. The liquid mixture is drawn into a preformed film which is allowed to solidify. The preformed film is then cut to a preform film shape. The pourable liquid material also is sprayed onto, or a fastener dipped therein, to form a solid coating on a fastener. The curable liquid precursor is cured with the preform film shape or fastener coating brought into contact with an object to which the fastener is anchored.

### BRIEF DESCRIPTION OF THE DRAWINGS

FIG. 1 is a perspective view of an inventive curable film according to the present invention fashioned as a peelable tape; and

FIG. 2 is a cross-sectional view of an inventive curable film according to the present invention cured intermediate between a fastener and an object.

### DETAILED DESCRIPTION OF THE PREFERRED EMBODIMENTS

The present invention has utility as an adhesive or sealant. According to the present invention, a curable liquid precursor is mixed with a powdered polymer to form a mixture. The mixture is processed to form a pressure sensitive adhesive solid or semisolid preform shape. While it is not intended as a limitation on the practice of the present invention, an inventive film is believed to form through an inner penetration of the liquid curable precursor into a particle of polymer powder by a plastisol-type mechanism.

As used herein, the term “preform” is defined to include shaped solids or semisolids that have a tensile strength of at least one psi.

The present invention is operative with a variety of curable liquid precursors illustratively including anaerobic compositions, microencapsulated epoxies, heat cure epoxies, microencapsulated Michael addition systems, acrylic compositions, polyurethane compositions, olefinic compositions, and moisture cure systems. It is appreciated that the polymer powder operative herein is dictated by the solvation properties of the curable liquid precursor. A curable liquid precursor according to the present invention necessarily intercalates and thereby solvates the polymer powder. It is further appreciated that the curable, crosslinked liquid precursor upon cure into a solid polymer is readily ground to form a polymer powder that in some instances is solvated by more of the same curable liquid precursor operative in the present invention.

The present invention is hereafter detailed with respect to anaerobic cure systems; however, for illustrative purposes it is appreciated an anaerobic curable liquid precursor is readily replaced with any of the other above detailed classes of curable liquid precursors.

Poly- and mono-functional (meth)acrylate esters are well known anaerobic curing liquid precursors. One class of polymerizable esters useful have the general structure CH₂═C(R)COOR¹ where R is H, CH₃, C₂H₅ or Cl, and R¹ is C₁₋₈ mono- or bicycloalkyl, a 3 to 8-membered heterocyclic radial with a maximum of two oxygen atoms in the heterocycle, H, alkyl, hydroxyalkyl or aminoalkyl where the alkyl portion is C₁₋₈ straight or branched carbon atom chain.

Among other desirable polymerizable monomers useful in the present invention include those which fall within the structure:

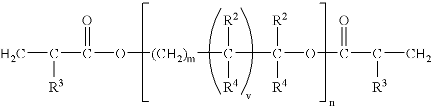

where R² may be selected from hydrogen, alkyl of 1 to about 4 carbon atoms, hydroxyalkyl of 1 to about 4 carbon atoms or

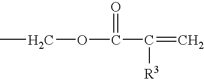

R³ may be selected from hydrogen, halogen, and alkyl of 1 to about 4 carbon atoms and C₁₋₈ mono- or bicycloalkyl, a 3 to 8-membered heterocyclic radical with a maximum of 2 oxygen atoms in the ring;

R⁴ may be selected from hydrogen, hydroxy and

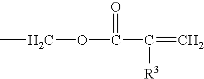

m is an integer equal to at least 1, e.g., from 1 to about 8 or higher, for instance from 1 to about 4;

n is an integer equal to at least 1, e.g., 1 to about 20 or more; and

v is 0 or 1.

Other desirable acrylate ester monomers are those selected from urethane acrylates within the general structure:

(CH₂═CR⁵C(O)O—R⁶—O—C(O)NH)₂R⁷

where R⁵ is H, CH₃, C₂H₅ or halogen, such as Cl; R⁶ is (i) a C₁₋₈ hydroxyalkylene or aminoalkylene group, (ii) a C₁₋₆ alklamino-C₁₋₈ alkylene, a hydroxyphenylene, aminophenylene, hydroxynaphthalene or amino-naphthalene optionally substituted by a C₁₋₃ alkyl, C₁₋₃ alkylamino or di-C₁₋₃ alkylamino group; and R⁷ is C₂₋₂₀ alkylene, alkenylene or cycloalkylene, C₆₋₄₀ arylene, alkarylene, aralkarylene, alkyloxyalkylene or aryloxyarylene optionally substituted by 1-4 halogen atoms or by 1-3 amino or mono- or di-C₁₋₃ alkylamino or C₁₋₃ alkoxy groups; or acrylates within the general structure:

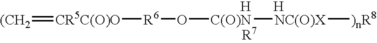

where R⁵, R⁶, and R⁷ are as given above; R⁸ is a non-functional residue of a polyamine or a polhydric alcohol having at least n primary or secondary amino or hydroxy groups respectively; X is O or NR⁹ where R⁹ is H or a C₁₋₇ alkyl group; and n is an integer from 2 to 20.

Among the specific monofunctional polymerizable acrylate ester monomers particularly desirable, and which correspond to certain of the structures above, are hydroxypropyl methacrylate, 2-hydroxyethyl methacrylate, methyl methacrylate, tetrahydrofurfuryl methacrylate, cyclohexyl methacrylate, 2-aminopropyl methacrylate and the corresponding acrylates.

Specific polyfunctional monomers which are desirable include polyethylene glycol dimethacrylate and dipropylene glycol dimethacrylate.

Other desirable polymerizable acrylate ester monomers useful in the instant invention are selected from the class consisting of the acrylate, methacrylate and glycidyl methacrylate esters of bisphenol A. Particularly desirable among all of the free-radical polymerizable monomers mentioned are ethoxylated bisphenol-A-dimethacrylate (“EBIPMA”).

Mixtures or copolymers of any of the above-mentioned free-radical polymerizable monomers can be employed.

Polymerizable vinyl monomers may also be optionally incorporated and are represented by the general structure:

R¹⁰—CH═CH—R¹⁰

where R¹⁰ is alkyl, aryl, alkaryl, aralkyl, alkoxy, alkylene, aryloxy, aryloxyalky, alkoxyaryl, aralkylene, OOC—R¹, where R¹ is defined above, can also be effectively employed in the instant composition.

Copolymers or mixtures of monomers disclosed herein with other compatible monomers are also contemplated.

Among the polymerizable polyacrylate esters utilized in accordance with the present invention include those which are exemplified but not restricted to the following materials: di-, tri-, and tetra-ethylene glycol dimethacrylate, dipropylene glycol dimethacrylate, polyethylene glycol dimethacrylate, di(pentamethylene glycol) dimethacrylate, tetraethylene glycol diacrylate, tetraethylene glycol di(chloroacrylate), diglycerol diacrylate, diglycerol tetramethacrylate, tetramethylene dimethacrylate, ethylene dimethacrylate, neopentyl glycol diacrylate and trimethylol propane triacrylate. The foregoing monomers need not be in the pure state, but may comprise commercial grades in which inhibitors or stabilizers, such as polyhydric phenols, quinones, and the like are included. These materials function as free radical inhibitors to prevent premature polymerization. It is also within the scope of the present invention to obtain modified characteristics for the cured composition by utilization of one or more monomers either from those listed above or additional additives such as unsaturated monomers, including unsaturated hydrocarbons and unsaturated esters.

The compositions of the present invention generally require a polymerization agent which initiates or otherwise promotes the polymerization of the monomer. In the case of anaerobic compositions, peroxy initiators are generally employed. However, the invention is not limited to anaerobic compositions and consequently other polymerization promoting materials, such as free radical promoters and initiators, metal catalysts and the like may be employed suitable to the chosen monomer and/or polymerizable composition.

The peroxy initiators useful in anaerobic compositions of the present invention include the hydroperoxy polymerization inhibitors and most preferably the organic hydroperoxide inhibitors having the formula ROOH, where R generally is a hydrocarbon radical containing up to about 18 carbons, desirably an alkyl, aryl or aralkyl radical containing up to about 12 carbon atoms. Typical examples of such hydroperoxides include cumene hydroperoxide, methylethylketone hydroperoxide as well as hydroperoxides formed by the oxygenation of various other hydrocarbons such as methylbutene, cetane and cyclohexane. Other peroxy initiators such as hydrogen peroxide or materials such as organic peroxides or peresters which hydrolyoize or decompose to form hydroperoxides may also be employed.

The peroxy initiators commonly employed in anaerobic compositions typically comprise less than about 20% by weight of the composition. Preferably, initiators are employed in lower levels such as 0.1% to about 10% by weight of the total composition.

Other materials can be added to the polymerizable monomers. Anaerobic polymerizable compositions typically employ stabilizers, accelerators, thickeners, coloring agents and the like in suitable amounts for their intended purposes.

Inhibitors and chelators, well recognized in the art for imparting stability to polymerizable compositions, are recommended. It is preferred that they be added to the composition prior to adding the polymeric matrix material. Those inhibitors useful in the present composition may be selected from any of the known inhibitors including those selected from hydroquinones, benzoquinones, naphthoquinones, phenanthraquinones, anthraquinones, and substituted compounds of any of these. Among the chelators which may be optionally present in the adhesive composition are the beta-diketones, ethylenediamine tetraacetic acid (“EDTA”) and the sodium salt of EDTA. Both the inhibitors and chelators may be effectively employed in levels of about 0.1 to about 1% by weight of the monomer, without adversely affecting the speed of cure of the polymerizable adhesive composition.

Thickeners, plasticizers, pigments, dyes, diluents, fillers, and other agents common to the art can be employed in any reasonable manner to produce desired functional characteristics, providing they do not significantly interfere with the monomer polymerization. Inert fillers are present in relatively high amounts as compared to conventional threadlocking systems. Most desired are fillers which add lubricity and sealing characteristics to the compositions. TEFLON (polytetrafluoroethylene) and polyethylene are non-limiting examples.

Specific examples include a one pack anaerobic thread locker containing 90 to 100% polyethylene glycol dimethacrylate, 1 to 10% dimethylbenzyl hydroperoxide, 1 to 10 total weight percent saccharin, and 0.1 to 1 total weight percent N,N-dialkyltoluidine (sold by Permatex as Item No. 29020).

A polymer powder operative as a component of the present invention is only limited by the requirements that it be solvated by the curable liquid precursor component. In the instance where curable liquid precursor is polyethylene glycol dimethacrylate, suitable polymer powders illustratively include polyalkyl methacrylates, such as polymethyl methacrylate; polyethylene oxides, polyalkylene glycols, such as polyethylene glycol and polypropylene glycol; cured and ground polyethylene glycol methacrylate; PVC, polyvinyl alcohol, EVA, etc. The primary requirements are that the polymer be thermoplastic and have a glass transition above room temperature. The higher the MW, the lower the level of polymer percent needed to achieve a given strength.

A polymer powder operative in the present invention typically is free-flowing powder at 20° Celsius. Typical polymer powder particulate sizes have an average domain size of from 5 to 500 microns. Preferably, the average domain size of polymer powder is from 10 to 100 microns. It is appreciated that the average domain size of a polymer powder has a significant effect on the rate of polymer powder solvation.

An inventive form is created by mixing of a curable liquid precursor with a polymer powder to form a homogeneous pourable liquid. An inventive form according to the present invention includes polymer powder present in an amount that varies depending on the desired form characteristics and typically ranges from 2 to 80 total weight percent polymer powder. Generally, pressure sensitive solid adhesive forms according to the present invention include from 2 to 50 total weight percent polymer powder whereas a more rigid, less tacky curable form typically includes from 5 to 80 total weight percent polymer powder.

An inventive process includes admixing polymer powder into curable liquid precursor. Upon obtaining a homogeneous pourable liquid mixture, a form is drawn down from the liquid mixture, typically onto a substrate. The form is drawn by methods conventional to the art such as spreading, filleting and the like. The spread mixture is then converted through what is believed to be a plastisol-type mechanism either by standing at 20° C. for a time from about 1 to 72 hours, depending on the nature of the mixture constituents, or more readily through the addition of heat. Subsequent to solidification, the form is peeled from the drawing substrate and optionally cut, overlayered with various coatings such as pressure adhesives, pigments, metalized gaseous barrier layers and the like. The resulting solid form retains the ability to further cure through the reaction of the curable liquid precursor through polymerization. It is appreciated that the curing conditions for the curable liquid precursor are dependent on the nature thereof yet are not appreciably changed through the creation of an inventive preform.

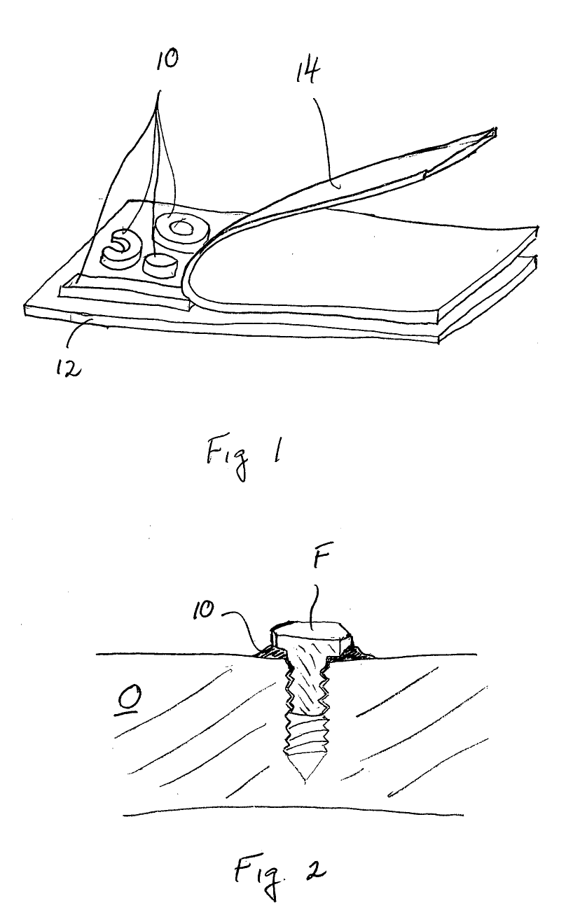

In a particular embodiment of the present invention, an inventive form is drawn into a film on a substrate and allowed to solidify. As used herein, drawing of a film is defined to include the process of casting, pulling and extruding a material into a film. The resulting preform film is stamped into the shape of a disk, a washer, a U-shaped piece, a strip, a regular or irregular polygon as shown at 10 in FIG. 1. It is intended that the shape is sized to engage the shaft of a conventional fastener such as a screw, bolt, nail or rivet and in the process of securing the fastener to an object, the shape is deformed and fills anaerobic spaces between the fastener and object to cure therein. Optionally, the preform is cooled to modify form rigidity and thereby facilitate stamping. Preferably, the substrate for solidification is a peelable backing sheet 12. Alternatively, the resulting shapes 10 are placed on the peelable backing sheet 12. Optionally, the shapes 10 are overlayered with a second sheet of peelable backing material 14. The resulting shapes 10 are stored under conditions that preclude spontaneous cure of the liquid precursor component of the shapes 10. The shapes 10 typically have a thickness of 0.01 to 10 millimeters and preferably from 0.5 to 3 millimeters. In the instance where the shapes 10 include an anaerobic curable liquid precursor, storage in air is appropriate and the compression of the shape 10 between a threaded fastener and a complementary threaded bore is sufficient to exclude air and thereby induce cure. Alternatively, a strip or patch is inserted at the interface between two interlocking structures such as pipe and/or flanges or overlying a surface imperfection. A patch over a surface imperfection is girdled or otherwise secured to the repaired substrate with the exclusion of air so as to induce cure. It is appreciated that a substitute for such a patch having an oxygen permeability of less than about 0.3 grams per 100 cm² per 24 hours at 20° C. is often sufficient to induce anaerobic cure therethrough. Press fitting of other structures together is appreciated to exclude air with the deformation of an inventive shape 10 and thereby induce cure.

As shown in FIG. 2, a shape 10 engages a fastener head underside H as the fastener engages an object O. The shape 10 is compressively deformed. In the instance where the shape 10 includes an anaerobic adhesive, the preform material compressed into spaces is induced to cure through air exclusion. A shape requiring a cure initiator begins to cure either through applying an initiator solution as part of the fastener securement, or preferably, through rupture of initiator encapsulants within the shape 10 during compression.

The following examples are given for the purpose of illustrating various embodiments of the invention and are not meant to limit the present invention in any fashion.

### EXAMPLE 1

To 60 grams of polyethylene glycol dimethacrylate anaerobic adhesive (Permatex, Item No. 29020), 40 grams of polymethyl methacrylate is added. The polymethyl methacrylate having a mean particle size of about 61 microns, a glass transition temperature of 90° C. and a reduced viscosity of 325 cubic centimeters per gram (CHCL₃, 20° C.; end relative 1.1-1.2) and sold by ROHM America as DEGALAN® 4893F. Upon mixing in air until a pourable liquid mixture results. A film is drawn down on a Teflon coated panel and heated to 82° Celsius for 10 minutes. Upon cooling to 20° Celsius, a stretchy, slightly tacky preform results. The form is squeezed tightly between CRS lap shears and allowed to cure overnight at room temperature, then cured 4 hours at 82° Celsius. A strength of 70 kilograms per square centimeter is recorded for the resulting cured article.

### EXAMPLE 2

The process of Example 1 was repeated and the resulting film is overcoated with a copper containing primer and cured overnight at 20° Celsius. A lap shear strength of 70 kilograms per square centimeter is noted.

### EXAMPLE 3

The process of Example 1 is repeated with the exception that 90 total weight percent 29020 anaerobic adhesive is used instead of 60 total weight percent with the remainder of the composition being DEGALAN® 4893F powder. After mixing to form a thin liquid mixture, a film is drawn down on a paper backed aluminum foil laminate and heated at 82° Celsius for 10 minutes. After cooling, the resulting form is cut into strips that have the property of being a pressure sensitive foil tape. The tape is adhered to a copper panel and heated overnight to 82° Celsius. Upon cooling, the resulting cured tape is adherent to the copper panel and could not be removed without destroying the tape.

### EXAMPLE 4

The tape of Example 3 is cut to a shape to match the anchoring plate for a vehicle rearview mirror and adhered through the inherent tack of the tape between the rearview mirror mount and the interior of a vehicle windshield. After curing for 16 hours at 18° Celsius, a rearview mirror was secured to the mount. The cured adhesive has retained the rearview mirror in place for in excess of one year.

Any patents or publications mentioned in the specification are indicative of the levels of those skilled in the art to which the invention pertains. These patents and publications are herein incorporated by reference to the same extent as if each individual patent or publication was specifically and individually indicated to be incorporated by reference.

The foregoing description is illustrative of particular embodiments of the invention, but is not meant to be a limitation upon the practice thereof. Modifications that remain within the spirit of the invention will be apparent to one skilled in the art upon reading of the specification; these modifications and equivalents thereof are intended to be encompassed within the appended claims.

1. A curable preform comprising:
a curable liquid precursor; and
a polymer powder mixed therethrough such that the preform has a tensile strength of greater than one pound per square inch and is a film shape selected from the group of: a disk, a washer, U-shaped piece, a strip, a regular polygon and an irregular polygon, sized to engage a fastener head underside.

2. The preform of claim 1 wherein the film shape is a washer.

3. The preform of claim 1 wherein the film is a U-shaped piece.

4. The preform of claim 1 wherein the film shape is a disk.

5. The preform of claim 1 wherein the film shape has a thickness of between 0.1 and 10 millimeters.

6. The preform of claim 1 comprising 2 to 50 total weight percent of said polymer powder and acting as a pressure sensitive adhesive.

7. The preform of claim 1 comprising 5 to 80 total weight percent of said polymer powder and functioning as a low tack curable film.

8. The preform of claim 1 wherein said curable liquid precursor cures anaerobically.

9. The preform of claim 4 wherein said curable liquid precursor is an acrylate.

10. The form of claim 9 wherein said powder polymer is selected from a group consisting of: poly(C₁-C₄)methacrylate, polyethylene oxide, polyvinyl chloride, and polyglycol, and said monofunctional polyvinyl alcohol, ethylene vinyl acetate, and polyvinyl pyrrolidone acrylate cured and ground.

11. The preform of claim 1 wherein said curable liquid precursor is selected from the group consisting of:
anaerobic compositions, microencapsulated epoxies, heat cure epoxies, microencapsulated Michael addition systems, acrylic compositions, polyurethane compositions, olefinic compositions, and moisture cure systems.

12. The preform of claim 1 wherein said polymer powder has an average domain size of from 5 to 500 microns.

13. The preform of claim 12 wherein said polymer powder has an average domain size of from 10 to 100 microns.

14. The preform of claim 1 wherein said polymer powder is selected from a group consisting of: a thermoplastic polymer compatible with the curable liquid precursor that has a glass transition temperature above room temperature.

15. The preform of claim 1 wherein said curable liquid precursor is selected from the group consisting of: an anaerobic composition, an epoxy composition, an acrylic composition, an alkyd composition, an acrylic composition, a polyurethane composition, an olefinic composition, and a combination thereof.

16. A commercial package comprising a preform according to claim 1 in contact with a peelable backing.

17. The package of claim 16 further comprising a second peelable backing in simultaneous contact with said form.

18. The package of claim 16 wherein said form cures anaerobically.

19. A process for creating a solid or semisolid curable preform comprising the steps of:
admixing with 20 to 98 total weight percent of a curable liquid precursor a polymer powder in an amount of from 2 to 80 total weight percent to form a pourable liquid mixture;
drawing a preform film from said pourable liquid mixture;
allowing said film to solidify; and
cutting said film to a preform film shape.

20. The process of claim 19 wherein the shape is selected from the group consisting of: a disk, a washer, a U-shaped piece, a strip, a regular polygon and an irregular polygon.

21. The process of claim 19 wherein said curable liquid precursor cures anaerobically.

22. The process of claim 21 wherein cure is induced with said preform intermediate between glass and metal.

23. The process of claim 22 wherein said metal is a rearview mirror mount.
